(19) United States
(12) Patent Application Publication
(10) Pub. No.: US 2003/0046172 A1
(43) Pub. Date: Mar. 6, 2003

(54) Shopping cart merchandise pickup

(75) Inventors: Maria Azua Himmel, Yorktown Hts., NY (US); Newton James Smith JR., Austin, TX (US); Herman Rodriguez, Austin, TX (US); Clifford Jay Spinac, Austin, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, ARMONK, NY

(21) Appl. No.: 09/942,786

(22) Filed: Aug. 30, 2001

(51) Int. Cl. G06F 17/60

(52) U.S. Cl. 705/26

(57) ABSTRACT

Online shopping including purchasing an electronic item from a merchant web site, wherein the purchasing is carried out by use of a client shopping cart, wherein the client shopping cart further comprises a merchandise pickup facility installed on a client, wherein the client is coupled for data communications to the merchant web site; downloading, to the client, the electronic item through the merchandise pickup facility to the client; and installing the electronic item through the merchandise pickup facility on the client.

### BACKGROUND OF THE INVENTION

1. Field of the Invention

The invention relates generally to online shopping, and in particular, to an improved shopping cart application for facilitating online shopping.

2. Description Of Related Art

Online shopping has become increasingly popular on the World Wide Web (“web”). There are currently thousands of merchant web sites offering products and services for sale. At many of these merchant web sites, virtual “shopping carts” are available customers. Generally, these so-called shopping carts are server-side software applications that permit customers, who are browsing a merchant web site, to conveniently select and purchase items advertised at the site. Shopping cart software typically generates web pages presentable to shoppers, where the web pages show lists of items that the shoppers have selected for purchase. The web pages can also include user-selectable options for altering the selections and for automatically “checking out”, or purchasing the selected items in the shopping cart.

Although web-based shopping carts have been a boon to online shopping, their current implementation presents some limitations. One limitation is that available shopping cart applications are server based, meaning that the shopping carts they present are tied to a particular web site. Thus, under server based implementations, an online shopper must create a different shopping cart for each merchant web site visited. A shopping cart cannot be easily “taken” from one merchant web site to another, and therefore, a shopper may have to reenter product and personal information each time he/she connects to a different merchant web site.

The web technology that we have today uses electronic shopping carts to purchase items on web sites; however, after purchasing electronic items the customer has to follow a manual process to download/install/configure these electronic items. The manual processes are burdensome and prone to error, involving as they do, determination of subdirectory locations, available disk space, operating system compatibility, encryption decisions, compression operations such as zipping and unzipping files, and so on. Also, these manual download processes are usually performed sequentially or synchronously with the purchase; that is, when one makes a purchase, the download must proceed immediately. The download are time consuming also, and the downloads are necessarily followed by installation processing and setup, processes that are even more burdensome, time consuming, and complex than the downloads.

For all these reasons, there is an ongoing need in the art for improvement in the experience and processing of purchase, delivery, and installation of electronic items purchased online.

### SUMMARY

Embodiments of the invention include methods of online shopping. In typical embodiments online shopping includes purchasing an electronic item from a merchant web site wherein the purchasing is carried out by use of a client shopping cart. In typical embodiments the client shopping cart includes a merchandise pickup facility installed on a client. A client is coupled for data communications to the merchant web site. Typical embodiments also include downloading, to the client, the electronic item through the merchandise pickup facility to the client; and installing the electronic item through the merchandise pickup facility on the client.

Typical embodiments of the invention include a merchandise pickup facility including application software integrated within the client shopping cart. In typical embodiments a merchandise pickup facility includes a data communications software application installed upon the client and connected to the client shopping cart through an interface. A merchandise pickup facility also includes software integrated within the client as a plug-in wherein the merchandise pickup facility is connected to the client shopping cart through an interface.

Typical embodiments of the invention include downloading an electronic item which includes downloading the electronic item to the client through a service provider site upon which is installed a remote merchandise pickup facility. Typical embodiments further also include scheduling the downloading. The downloading is performed in accordance with a predefined schedule, wherein the schedule is stored in computer memory on the client. In typical embodiments, the client has a temporary web address and a permanent web address. In typical embodiments, the downloading is also performed in accordance with a predefined schedule, wherein the schedule is stored in computer memory on the merchant web site.

In addition to the method aspects of the invention, further aspects of the invention include embodiments as computer systems and computer program products. The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a diagram illustrating an embodiment of an online shopping system in accordance with the present invention.

FIG. 2 is a flow chart illustrating operation of an embodiment of the shopping cart application shown in FIG. 1.

FIG. 3 is a flow chart illustrating an embodiment of a method that uses the shopping cart application of FIG. 1 to create an online shopping cart.

FIG. 4 is a block diagram of an embodiment of an online shopping system in accordance with the present invention in which the client shopping cart includes a merchandise pickup facility.

FIG. 5 is a block diagram of an embodiment of an online shopping system according to the present invention in which the client shopping cart is connected to a merchandise pickup facility through an interface.

FIG. 6 illustrates in a control flow diagram embodiments of the method aspect of the present invention.

### DETAILED DESCRIPTION OF EXEMPLARY EMBODIMENTS

### Introduction

The present invention is described to a large extent in this specification in terms of methods of online shopping. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory data elements and programmed steps of the method of the invention for execution by a processing unit as computer program instructions, which computer memory includes electronic circuits configured to store data and program instructions. The invention also is embodied in a computer program product, such as a diskette or other recording medium, for use with any suitable data processing system.

Embodiments of a computer program product typically are implemented by use of any recording media for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

### Definitions

In this specification, the terms “field,” “data element,” and “attribute” are used as synonyms, referring to individual elements of digital data. Aggregates of data elements are referred to as “records” or “data structures.” Definitions of complex data structures that include member methods, functions, or software routines in addition to data elements are referred to as “classes.” Instances of complex data structures are referred to as “objects” or “class objects.”

“Client” means any device capable of accessing a server or a web site through a network. Examples of clients are hand-held personal computers, special purpose devices that are network enabled, internet-capable personal data organizers, and others that will occur to those of skill in the art. Various embodiments of clients are capable of wired and/or wireless network access. The use as a client device of any instrument capable of accessing a server through a network is well within the present invention.

A “browser” is a software application typically installed and running upon a client device, the browser operating to download to the client device from a web server documents developed in a markup language, display the contents of the documents, and to the extent that the documents include tags identifying other documents to download or other actions to be taken, downloading the documents or taking the actions.

“Content” means digital, location-specific, program content. In typical embodiments, content is stored in computer memory for transmission to clients where it is stored and displayed. Content includes all forms of digital program content including, for example, text, HTML documents, XML documents, graphic images in JPEG files, audio in MP3 files, and video in MPEG files. These forms of content are listed merely for illustration. Many forms of content will occur to those of skill in the art, and they are all well within the scope of the present invention.

“Content server” refers to any computer server coupled for data communications to location-specific devices and, through the location specific devices, to clients. Content servers store and retrieve under program control location-specific content for transmission to, storage upon, and display upon clients.

“Coupled for data communications” means any form of data communications, wireless, infrared, radio, internet protocols, HTTP protocols, email protocols, networked connections, direct connections, dedicated phone lines, dial-ups, and other forms of data communications as will occur to those of skill in the art. The phrases “coupled for data communications” and “connected for data communications” are used synonymously in this specification.

“DHCP” stands for “Dynamic Host Configuration Protocol,” a standard networking protocol enabling dynamic internet protocol network configuration including particularly dynamic assignment of network addresses.

“Electronic item” means anything capable of embodiment in digital form, including software programs, software packages, software applications, software solutions, electronic tickets, travel plans, hotel reservations, electronic books, music, movies, video clips, audio files, graphic images, digital pictures, electronic greeting cards, the many forms of services that delivered electronically, and so on.

“Interface” means a facility for effecting calls to software routines among more than one software program. That is, a facility supporting calls from software routines in one program to software routines in another program. An example of an interface is an “API” or Application Program Interface, an organized set of calls to routines, protocols, and tools brought together for purposes of helping programmers build software applications.

The term “network” is used in this specification to mean any networked coupling for data communications. Examples of networks useful with the invention include wireless networks, intranets, extranets, internets, local area networks, wide area networks, and other network arrangements as will occur to those of skill in the art. The use of any networked coupling from clients to one or more merchant web sites is well within the scope of the present invention.

“URL” means Uniform Resource Locator, the standard method of associating world wide web data locations with network addresses for data communications. Typical forms of URL include web site address, that is, a network address or a domain name that resolves to a network address identifying a particular computer or other resource on an internet. Typical forms of URL include also a location within a file structure or subdirectory location where files, documents, programs, or other data is located on the computer or other resource identified by the network address or domain name.

“World Wide Web,” or more simply “the web,” refers to the well-known system of internet protocol (“IP”) servers that support specially formatted documents, documents formatted in HTML (“HyperText Markup Language”), XML (“Extended Markup Language”), or other languages. The term “web” is used in this specification also to refer to any server or connected group or interconnected groups of servers that implement the HyperText Transport Protocol, “HTTP,” regardless whether such servers or groups of servers are coupled to the world wide web as such.

### DETAILED DESCRIPTION

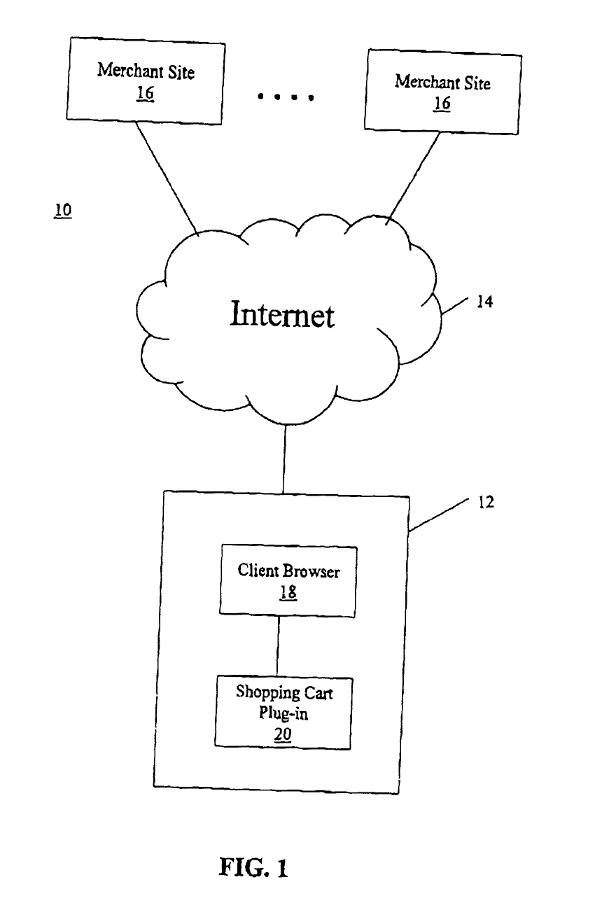

Turning now to the drawings, and in particular to FIG. 1, there is illustrated an exemplary online shopping system (10) in accordance with one embodiment of the present invention. The online system (10) includes a remote client (12) communicating with a plurality of merchant sites (16) by way of a computer network (14), such as the Internet. The merchant sites (16) typically are websites for offering goods and services for sale. The merchant sites typically are built using commercially-available server hardware and web server software configured to support the online shopping cart described herein.

The remote client (12) in many typical embodiments, for example, is a web-enabled device, such as a personal computer, personal digital assistant, cellular telephone, pager, or the like. The remote (12) includes a client browser (18) and a shopping cart plug-in (20). The client browser (18) in typical example embodiments is any software application suitable for accessing websites over the internet, such as the Internet Explorer, available from Microsoft Corporation. Although shown in FIG. 1 as a software plug-in, the client shopping cart disclosed herein in typical embodiments, for example, is implemented in any suitable form, such as an application program, firmware, or as a custom application specific integrated circuit.

The client shopping cart plug-in (20) is a software application providing an online shopping cart usable at the merchant sites (16). The client shopping cart can contain items from different merchant sites. The client shopping cart plug-in (20) provides advantage in that it permits a user to shop across multiple websites, and also allows check-out to be accomplished in a single step. Another advantage of the shopping cart plug-in (20) is that it permits the contents of the cart to be visible to the various merchants on the web. For example, in situations where the shopper selects an item at one merchant, and later visits another merchant, the latter merchant could see the selected item in the cart, and could offer a better price or product selection. This provides an opportunity for web merchants to “bid” better prices.

Another scenario is that merchants can offer discounts when they detect items in a shopping cart that were selected from other websites having a preferred relationship with the current website or offering related items or services. For example, if a shopper has placed a travel package to Cancun in a shopping cart, and then visits a scuba diving website, the shopper could be provided with a 5% discount on purchases at the scuba diving site because the scuba diving web site was able to see the travel package to Cancun.

A further advantage of the shopping cart plug-in (20) is that it is easier to use because it can be configured only once to store user information and the same information can be used on every merchant site (16).

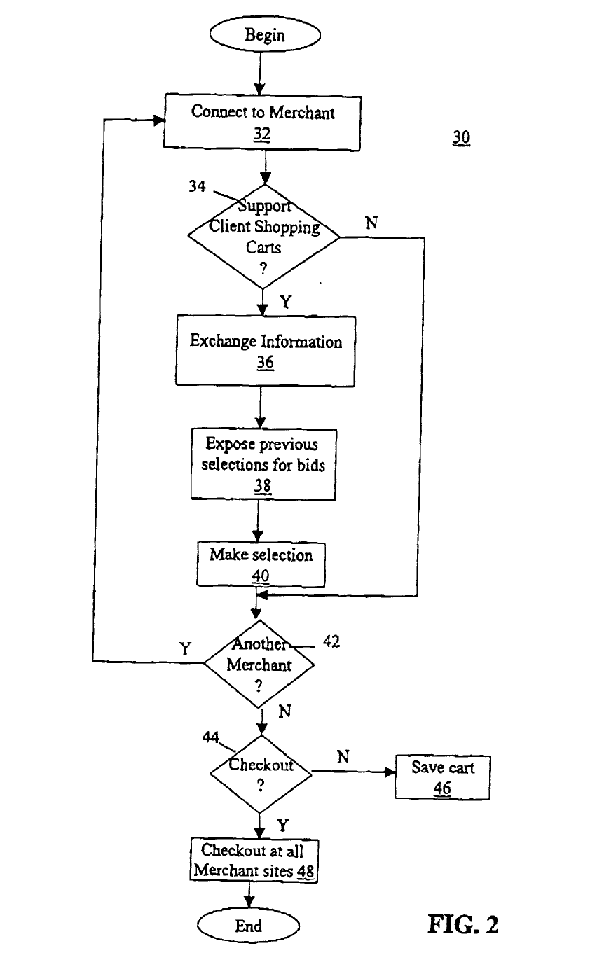

FIG. 2 is a flow chart (30) illustrating operation of the shopping cart application (20) shown in FIG. 1. In step 32, the browser (18) connects to one of the merchant websites (16). The browser (18) can connect to the site and exchange information using the hypertext transfer protocol (HTTP) or any other suitable protocol. In decision step (34), a check is made to determine whether the merchant site supports the client shopping cart plug-in (20). If not, the shopper is notified by the browser (18), and may select another merchant (step 42). If the merchant site indicates to the remote client (12) that it supports the shopping cart plug-in (20), shopping cart information is exchanged between the remote client (12) and the merchant site (16) (step 36).

Although the invention is not so limited, the client (12) running the shopping cart plug-in (20) can provide a merchant web server with the following shopping cart data: the user-selected name of the shopping cart, a description of each item in the shopping cart, the uniform resource locators (URLs) of the sites that conduct the check-out for the items in the shopping cart, and an indicator of whether of not each item in the shopping cart is to be included during check-out. The user-selected name of the shopping cart can be correlated to its use. For instance, a user can have a “family” shopping cart, as well as a separate “business” shopping cart. The business shopping cart could be customized in the shopping cart plug-in to keep track of tax deductible items purchased during the year.

In step 38, information about previous item selections, i.e., items currentlyin the shopping cart, can be exposed to the merchant website to solicit competitive bids from the merchant. This involves the transfer of item information from the shopping cart plug-in (20) to the merchant site (16). The merchant site (16) can be configured to compare product information in the shopping cart to that available from the merchant. If similar items are detected, the merchant site can automatically notify the shopper, by way of the browser (18), that it can offer the same items in the shopping cart at a better or discounted price.

If a user does not want items in the shopping cart to be exposed to other merchant web sites, the user can selectively “hide” the items in the cart. A web page can be generated by the plug-in for allowing the user to hide items. These hidden items are not visible to other web sites, except the one where they were originally selected. Although these items are not visible to other sites, they can nevertheless be purchased or discarded from the cart at check-out time.

In step 40, the shopper makes selections, such as selecting items for purchase from the merchant site or replacing items in the cart with those competitively bid by the merchant site. While shopping at the merchant website, when a user places an item in the shopping cart, the merchant server (16) sends the client shopping cart (20) the following information: a complete description of the item, the quantity of items selected, the cost of each item, the shipping cost of each item, an expiration date for the price guaranteed for each item, and identification of the information fields required to be submitted when checking out.

The check-out information fields can include items such as the shopper name, shipping address, shipping instructions, payment information, email address which confirmations are sent and the like. The user can view the contents of the shopping cart at any time and delete individual or all of the items in the cart. In addition to storing item and shopper information, the shopping cart plug-in can store electronic coupons and award points at the remote client (12), for redemption at check out or some later time.

In step 42, a check is made to determine whether another merchant site (16) has been selected. If so, the process returns to step 32, where a connection is made to the new merchant site. If another merchant is not selected, the shopping cart plug-in (20) can proceed to check-out (step 44) or the shopping cart can be stored.

If check-out is selected by the shopper, the shopping cart plug-in sends the product information to the various merchant sites (16) in an automatic manner (step 48). The shopping cart plug-in contacts each merchant site, via the URLs specified in the shopping cart, with a list of items to be purchased at the respective sites and the check-out information, as required for each merchant site.

The shopper can select which items are to be checked out. Those that are not selected for purchase can remain in the shopping cart for a user-specified time, or until the price guaranteed by the merchant expires.

If check-out information is not available to the plug-in, a plug-in dialogue is presented to the user. The dialogue permits the user to manually enter any missing information. To accomplish manual entry, a single form with accumulative list of required items is presented to the user. The form can be an HTML (hypertext markup language) page displayable by the browser (18).

For example, the user needs to enter the shipping address only once, if it stored in the browser preferences for the shopping cart. This address is the one that will be use during client check-out. If the shipping address is already stored in the client shopping cart, then the menu does not need to request a shipping address from the shopper during check-out, but may request a confirmation.

After completing the check-out process, the merchant sites can send the remote client (12) one or more check-out status objects, which are stored by the client plug-in (20), for tracking the status of orders. To track an order, a user can access the corresponding check-out status object using the plug-in (20), which then sends a tracking request to the URL of a merchant site. In response, the merchant site returns an order status update.

If the shopper decides not to check-out or to do a partial checkout, the contents and configuration of the cart are saved (step 46). The shopping cart and shopper data are stored locally at the remote client (12).

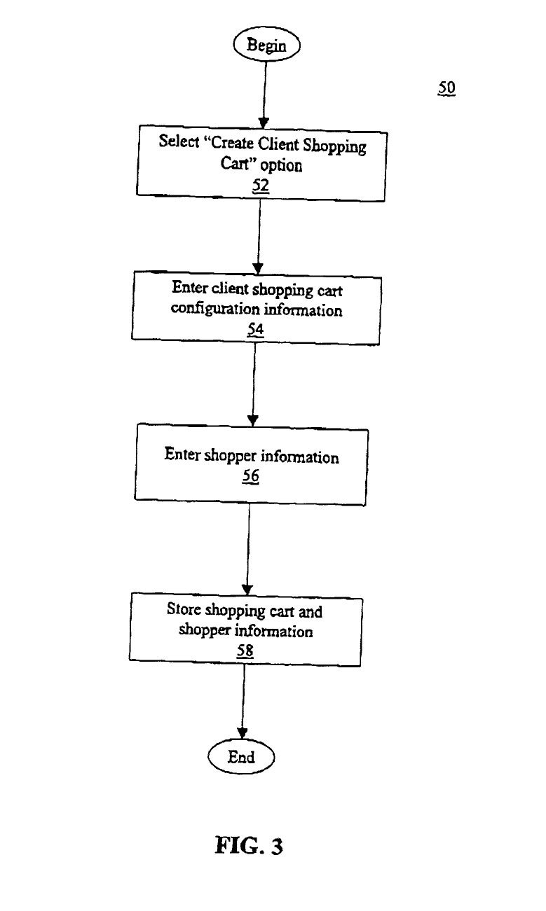

FIG. 3 is a flow chart (50) illustrating a method of using the shopping cart plug-in application of FIG. 1 to create an online shopping cart. In step 52, a user selects a “create shopping cart” option from a menu presented by the shopping cart plug-in (20) at the remote client (12). The menu can be presented by an HTML, Java, Java script, or any other suitable language for creating web pages. The menu option can present a series of forms that can be filled out and entered by the user in a step-by-step method. Using these forms, the user can enter shopping cart configuration information (step 54).

The configuration information includes a name for the shopping cart, a user ID and password for accessing the shopping cart, limitations on using the shopping cart, e.g., time of day limitations, spending limits, restrictions on merchant sites which can be visited, and the like. The time of day limitations can restrict when the shopping cart is used.

The length of time items are allowed to remain in the shopping cart can also be specified. A stored shopping cart will retain the items until the user-selected time limit expires. Also, items can be tagged with merchant selected expiration dates that guarantee a price for a certain time period. After the time period has expired, the items are automatically remove from the cart.

In addition, the user can set language and currency requirements, and can also require specific purchase approvals before check out can be completed. For example, a parent can create a shopping cart for a child and configure the shopping cart to require entry of a parent password before commencing the check-out process. Likewise, a boss can create an employee shopping cart with similar restrictions. In addition, the check out authorization can be specified for specific items.

Further, limits may be placed on what items are put in the shopping cart. For instance, a shopping cart can be configured so that alcoholic beverages can not be placed therein. Also, the shopping cart can be configured to allow purchases on behalf of another person.

In step 56, the user can enter shopper information corresponding to the shopping cart. The shopper information can include a shipping address, credit card information, and any other information specific to the user(s) of the shopping cart. In step 58, the shopping cart configuration information and shopper information is stored locally at the remote client (12). Alternatively, the information can be stored at a site on the web at a user-specified location. This information can be later retrieved by the shopping cart plug-in (20) while the user is visiting the various merchant sites (16) or checking out.

A user can create multiple shopping carts for different purposes. A shopping cart can be selected from a list of shopping carts using a pull-down menu on the browser (18), generated by the shopping cart plug-in (20).

The plug-in (20) can also support the transfer and combining of shopping carts. For example, a “family” shopping cart can be configured to include children‘s’ shopping carts, and thus, receive items from the children‘s’ shopping carts. Thus, a shopping cart can be place within another shopping cart. To transfer a shopping cart to another user, the plug-in generates a shopping cart object, which includes configuration and item information that can be sent to the user by way of email or some other suitable communications path. The recipient can either accept or decline the sent shopping cart.

The shopping cart plug-in (20) can be implemented in software using a standard programming language, such as Java™ or XML, and stored in a computer usable medium, such as a CDROM, solid-state memory, DVD, floppy disk, hard disk, or the like.

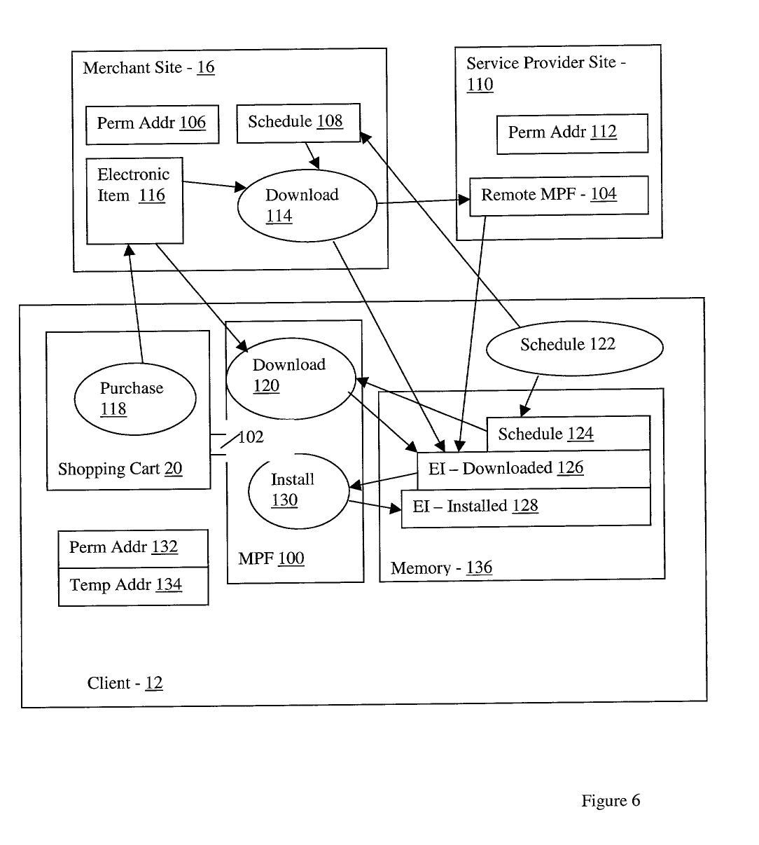

Turning now to FIG. 6, additional embodiments of the invention are shown as methods of online shopping. Typical embodiments as shown in FIG. 6 include purchasing (118) an electronic item (116) from a merchant web site (16) where the purchasing is carried out by use of a client shopping cart (20). In typical embodiments, the client shopping cart includes a merchandise pickup facility (100) installed on a client (12). In an embodiment as shown in FIG. 6, the merchandise pickup facility (100) is implemented as a separate software application on the client (12), the merchandise pickup facility being connected to the shopping cart (20) though an interface (102). In embodiments of the kind shown in FIG. 6, a client (12) is coupled for data communications to a merchant web site (16).

Typical embodiments also include downloading (120) the electronic item through the merchandise pickup facility to the client and installing (130) the electronic item through the merchandise pickup facility on the client.

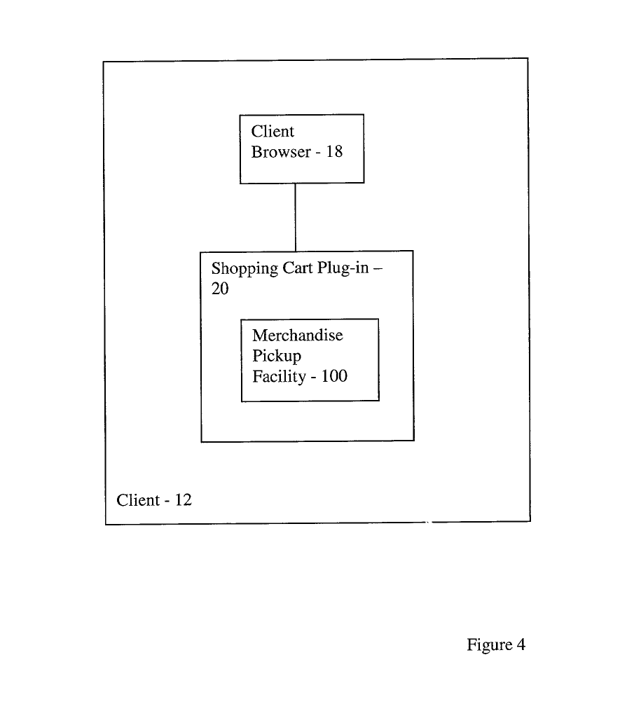

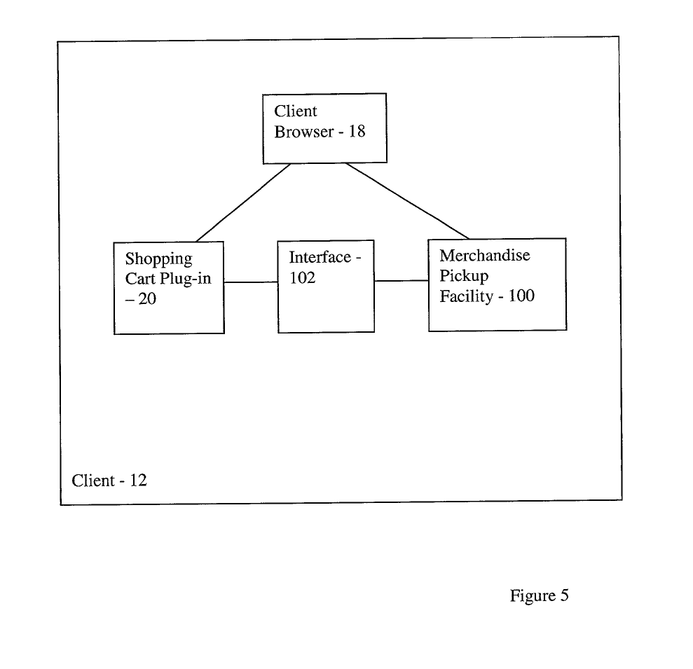

Typical embodiments of the invention, as shown in FIG. 4, include a merchandise pickup facility (100) including application software integrated within the client shopping cart (20). Typical embodiments of the kind illustrated in FIG. 5 include a merchandise pickup facility including a data communications software application installed upon the client and connected to the client shopping cart through an interface. In typical embodiments, a merchandise pickup facility also includes software integrated within the client as a plug-in wherein the merchandise pickup facility is connected to the client shopping cart through an interface.

Again as shown in FIG. 6, in typical embodiments the downloading (120) is performed in accordance with a predefined schedule (124), wherein the schedule (124) is stored in computer memory (136) on the client. Typically the desired download time for entry in the schedule is simply typed in by the user through a standard GUI prompt or dialogue box. In some embodiments the client (12) has a temporary web address (134). In other embodiments, the client has a permanent web address (132). In typical embodiments the downloading (114) is also performed in accordance with a predefined schedule (108), wherein the schedule (108) is stored in computer memory on the merchant web site (16).

Turning again to FIG. 6, typical embodiments of the invention are seen to include downloading the electronic item including downloading (114) the electronic item (116) to the client (12) through a service provider site (110) upon which is installed a remote merchandise pickup facility (104). In such embodiments, the service provider site has a permanent network address known to the merchant site. In embodiments using a service provider site, the user subscribes to a remote delivery service and receives notification of a permanent network address for the service provider site. The user records in the shopping cart the permanent address of the service provider site which in turn is provided to the merchant site at the time of a purchase. The merchant site then downloads (114) purchases to the service provider site (110) in accordance with a preset schedule (108). The service provider site accepts downloads on behalf of subscribers at any time of the day or night, seven days a week, including for example times when the client device is not available. In this fashion, purchases are effectively delivered from the merchant site asynchronously with respect to client availability.

Typical embodiments also include scheduling (122) the downloading. Schedules for downloads are entered by users at the time of purchases. For clients having permanent network addresses, schedules in typical example embodiments are registered on the selling merchant's site (108) or on the client (124). For clients having dynamically assigned network addresses, that is, network addresses that change from time to time, such as, for example, when a client connects to the network, then schedules in many such embodiments, are registered only on the client (124). In typical example embodiments, clients having dynamically assigned network addresses acquire the permanent network address of the merchant site at the time of the purchase and record that address in computer memory along with the schedule (124) so that the download function (120) in the merchandise pickup facility(100) knows at download time how to locate the merchant site. Thus is made apparent an advantage of the architecture illustrated in FIG. 6 where the merchandise pickup facility (100) is implemented as a separate software application on the client (12), the merchandise pickup facility being connected to the shopping cart (20) though an interface (102). In such an architecture, neither the shopping cart nor the browser needs to be present, enabled, or running at download time. At download time, the merchandise pickup facility, in typical embodiments of the kind illustrated, reads the schedule (124), connects to the merchant site at the permanent address of the merchant site, and downloads the electronic product (116) purchased earlier.

### Advantages

From the discussion above in this specification, persons of skill in the art will recognize among the advantages of the present invention the following. Embodiments of the invention, among other things, enable client shopping carts to automatically download, configure, and install electronic items. Customers are enabled to purchase online by use of the various embodiments of the present invention electronic items. In using embodiments of the present invention, customers don't waste time doing manual downloads, configurations, and installations of electronic items. Embodiments of the merchandise pickup facility of the present invention typically perform the download process when a client's system is idle and typically install electronic items comprising software on behalf of the client.

For example, if a customer buys three items (1) a software package, (2) a trip to Hawaii, and (3) one electronic book, the “Shopping Cart Merchandise Pickup” will establish communication with the appropriate server to download the software and install the software in the appropriate location following the configuration set within an embodiment of a merchandise pickup facility of the present invention. After downloading the software the merchandise pickup facility will contact another server to download the confirmation documents for the trip to Hawaii and optionally download also some electronic discount coupons for the hotel in Hawaii. In accordance with a schedule entered by the client, the electronic book in this example is not downloaded until after the vacation in Hawaii because the merchandise pickup facility reads the schedule establishing when the electronic book is to be downloaded to, for example, a hand-held electronic-book.

A further example of advantages of the present invention is the customer's ability by use of various embodiments of the invention to purchase items for delivery to others. For example, a customer selects a shopping cart of another user and specifies delivery instructions to the merchandise pickup facility of the other user so that the item is delivered on a specific date with an electronic gift card for a special occasion such as a birthday or anniversary. Alternatively, the customer purchases the item through the customer's own client shopping cart but specifies delivery in accordance with the schedule but through the other user's merchandise pickup facility, identifying the other user's merchandise pickup facility by URL, web address, or domain name.

It will be understood from the foregoing description that various modifications and changes may be made in the various embodiments of the present invention without departing from its true spirit. It is intended that the descriptions in this specification are for purposes of illustration only and are not to be construed in a limiting sense. The scope of the present invention is limited only by the language of the following claims.

What is claimed is:

1. A method of online shopping comprising the steps of:
purchasing an electronic item from a merchant web site,
wherein the purchasing is carried out by use of a client shopping cart,
wherein the client shopping cart further comprises a merchandise pickup facility installed on a client, and
wherein the client is coupled for data communications to the merchant web site;
downloading, to the client, the electronic item through the merchandise pickup facility on the client; and
installing the electronic item through the merchandise pickup facility on the client.

2. The method of claim 1 wherein the merchandise pickup facility comprises application software integrated within the client shopping cart.

3. The method of claim 1 wherein the merchandise pickup facility comprises a data communications software application installed upon the client and connected to the client shopping cart through an interface.

4. The method of claim 1 wherein the merchandise pickup facility comprises software integrated within the client as a plug-in wherein the merchandise pickup facility is connected to the client shopping cart through an interface.

5. The method of claim 1 wherein downloading the electronic item comprises downloading the electronic item to the client through a service provider site upon which is installed a remote merchandise pickup facility.

6. The method of claim 1 further comprising scheduling the downloading.

7. The method of claim 1 wherein the downloading is performed in accordance with a predefined schedule, wherein the schedule is stored in computer memory on the client.

8. The method of claim 7 wherein the client has a temporary web address.

9. The method of claim 7 wherein the client has a permanent web address.

10. The method of claim 1 wherein the downloading is performed in accordance with a predefined schedule, wherein the schedule is stored in computer memory on the merchant web site.

11. The method of claim 10 wherein the client has a permanent web address.

12. A system of online shopping comprising:
means for purchasing an electronic item from a merchant web site,
wherein the means for purchasing comprises a client shopping cart,
wherein the client shopping cart further comprises a merchandise pickup facility installed on a client, and
wherein the client is coupled for data communications to the merchant web site;
means for downloading, to the client, the electronic item through the merchandise pickup facility on the client; and
means for installing the electronic item through the merchandise pickup facility on the client.

13. The system of claim 12 wherein the merchandise pickup facility comprises application software integrated within the client shopping cart.

14. The system of claim 12 wherein the merchandise pickup facility comprises a data communications software application installed upon the client and connected to the client shopping cart through an interface.

15. The system of claim 12 wherein the merchandise pickup facility comprises software integrated within the client as a plug-in wherein the merchandise pickup facility is connected to the client shopping cart through an interface.

16. The system of claim 12 wherein means for downloading the electronic item comprises means for downloading the electronic item to the client through a service provider site upon which is installed a remote merchandise pickup facility.

17. The system of claim 12 further comprising means for scheduling the downloading.

18. The system of claim 12 wherein the means for downloading is operating in accordance with a predefined schedule, wherein the schedule is stored in computer memory on the client.

19. The system of claim 18 wherein the client has a temporary web address.

20. The system of claim 18 wherein the client has a permanent web address.

21. The system of claim 12 wherein the means for downloading is operating in accordance with a predefined schedule, wherein the schedule is stored in computer memory on the merchant web site.

22. The system of claim 21 wherein the client has a permanent web address.

23. A computer program product of online shopping comprising:
a recording medium;
means, recorded on the recording medium, for purchasing an electronic item from a merchant web site,
wherein the means, recorded on the recording medium, for purchasing comprises a client shopping cart,
wherein the client shopping cart further comprises a merchandise pickup facility installed on a client, and
wherein the client is coupled for data communications to the merchant web site;
means, recorded on the recording medium, for downloading, to the client, the electronic item through the merchandise pickup facility on the client; and
means, recorded on the recording medium, for installing the electronic item through the merchandise pickup facility on the client.

24. The computer program product of claim 23 wherein the merchandise pickup facility comprises application software integrated within the client shopping cart.

25. The computer program product of claim 23 wherein the merchandise pickup facility comprises a data communications software application installed upon the client and connected to the client shopping cart through an interface.

26. The computer program product of claim 23 wherein the merchandise pickup facility comprises software integrated within the client as a plug-in wherein the merchandise pickup facility is connected to the client shopping cart through an interface.

27. The computer program product of claim 23 wherein means, recorded on the recording medium, for downloading the electronic item comprises means, recorded on the recording medium, for downloading the electronic item to the client through a service provider site upon which is installed a remote merchandise pickup facility.

28. The computer program product of claim 23 further comprising means, recorded on the recording medium, for scheduling the downloading.

29. The computer program product of claim 23 wherein the means, recorded on the recording medium, for downloading is operating in accordance with a predefined schedule, wherein the schedule is stored in computer memory on the client.

30. The computer program product of claim 29 wherein the client has a temporary web address.

31. The computer program product of claim 29 wherein the client has a permanent web address.

32. The computer program product of claim 23 wherein the means, recorded on the recording medium, for downloading is operating in accordance with a predefined schedule, wherein the schedule is stored in computer memory on the merchant web site.

33. The computer program product of claim 32 wherein the client has a permanent web address.
